(19) United States
(12) Patent Application Publication
(10) Pub. No.: US 2025/0267510 A1
(43) Pub. Date: Aug. 21, 2025

(54) LOW LATENCY REDUCTION FOR REAL TIME APPLICATION TRAFFIC TRANSMISSION

(71) Applicant: Samsung Electronics Co., Ltd., Suwon-si (KR)

(72) Inventors: Yue Qi, Plano, TX (US); Vishnu Vardhan Ratnam, Frisco, TX (US); Boon Loong Ng, Plano, TX (US); Bilal Sadiq, Plano, TX (US); Junsu Choi, Suwon-si (KR); Peshal Nayak, Plano, TX (US); Rubayet Shafin, Frisco, TX (US)

(21) Appl. No.: 19/054,704

(22) Filed: Feb. 14, 2025

Related U.S. Application Data
(60) Provisional application No. 63/555,764, filed on Feb. 20, 2024.

(51) Int. Cl. H04W 28/06

(52) U.S. Cl. CPC H04W 28/06

(57) ABSTRACT

An access point (AP) for facilitating communication in a wireless network. The AP transmits, to one or more stations (STAs), a first frame that allocates a first resource unit (RU) for low-latency traffic transmission and a second RU for non-low-latency traffic transmission. The one or more STAs include a first STA with high priority access to the first RU and a second STA with low priority access to the first RU. The AP determines whether low-latency traffic for the first STA is queued for transmission. The AP transmits the low-latency traffic for the first STA with priority to the first STA via the first RU based on a determination that the low-latency traffic for the first STA is queued for transmission. The AP transmits traffic to the second STA via the first RU based on a determination that the low-latency traffic for the first STA is not queued for transmission.

### CROSS REFERENCE TO RELATED APPLICATION

This application claims benefit of U.S. Provisional Application No. 63/555,764, entitled “Low Latency Reduction for RTA Traffic Transmission,” filed on Feb. 20, 2024, in the United States Patent and Trademark Office, the entire contents of which are hereby incorporated by reference.

### TECHNICAL FIELD

This disclosure relates generally to a wireless communication system, and more particularly to, for example, but not limited to, low latency traffic transmission in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

This disclosure may be directed to improvements to a wireless communications system, more particularly to provide a mechanism and procedure for time division multiple access (TDMA)-based multiple access point (MAP) coordination.

An aspect of the disclosure provides an access point (AP) for facilitating communication in a wireless network. The AP comprises a memory and a processor coupled to the memory. The processor is configured to cause transmitting, to one or more stations (STAs) that are associated with the AP, a first frame that allocates a first resource unit (RU) for low-latency traffic transmission and a second RU for non-low-latency traffic transmission, wherein the one or more STAs include a first STA with high priority access to the first RU and a second STA with low priority access to the first RU. The processor is further configured to cause determining whether low-latency traffic for the first STA is queued for transmission. The processor is further configured to cause transmitting the low-latency traffic for the first STA with priority to the first STA via the first RU based on a determination that the low-latency traffic for the first STA is queued for transmission. The processor is further configured to cause transmitting low-latency traffic or non-low-latency traffic to the second STA via the first RU based on a determination that the low-latency traffic for the first STA is not queued for transmission.

In an embodiment, the processor is further configured to cause transmitting non-low-latency traffic to the second STA via the second RU. The low-latency traffic for the first STA is piggybacked to transmission of the non-low latency traffic to the second STA.

In an embodiment, the processor is further configured to cause determining that low-latency traffic for the first STA is queued for transmission after the transmitting the low-latency or non-low-latency traffic to the second STA via the first RU. The processor is further configured to cause stopping transmission of the low-latency traffic or the non-low-latency traffic to the second STA via the first RU. The processor is further configured to cause transmitting the low-latency traffic for the first STA with priority to the first STA via the first RU.

In an embodiment, the first frame includes information indicating whether a recipient STA is the first STA or the second STA.

In an embodiment, the first frame allocates the first RU to the first STA and the second STA.

In an embodiment, the processor is further configured to cause receiving, from the first STA, a second frame requesting high priority access to the first RU for low-latency traffic transmission. The processor is further configured to cause transmitting, to the first STA, a third frame indicating acceptance of the request in response to the second frame.

In an embodiment, the processor is further configured to cause transmitting, to the second STA, a fourth frame suggesting low priority access to the first RU for low-latency traffic or non-low-latency traffic. The processor is further configured to cause receiving, from the second STA, a fifth frame indicating acceptance of the suggestion in response to the fourth frame.

In an embodiment, the one or more STAs includes two or more first STAs. Each first STA has high priority access to the first RU. The transmitting the low-latency traffic to the first STA further comprises transmitting low-latency traffic with priority to one or more first STAs via the first RU.

In an embodiment, the first frame allocates two or more first RUs. Each first STA has high priority access to a respective first RU. The transmitting the low-latency traffic to the first STA further comprises transmitting low-latency traffic with priority to one or more first STAs via the two or more first RUs.

An aspect of the disclosure provides a station (STA) for facilitating communication in a wireless network. The STA comprises a memory and a processor coupled to the memory. The processor is configured to cause receiving, from an access point (AP) that is associated with the STA, a first frame that allocates a first resource unit (RU) for low-latency traffic transmission and a second RU for non-low-latency traffic transmission. The processor is further configured to cause determining whether the first RU is busy or idle for a predetermined duration. The processor is further configured to cause transmitting, to the AP, low-latency traffic or non-low-latency traffic based on a determination that the first RU is idle. The processor is further configured to cause abstaining from transmitting, to the AP, the low-latency or the non-low latency traffic based on a determination that the first RU is busy.

In an embodiment, the first frame includes information indicating that the STA has low priority access to the first RU.

In an embodiment, the determining whether the first RU is busy or idle further comprises detecting a frame on the first RU and determining that a preamble of the frame is boosted in power by a predetermined value.

In an embodiment, the processor is further configured to cause receiving, from the AP, a second frame suggesting low priority access to the first RU for low-latency or non-low-latency traffic. The processor is further configured to cause transmitting, to the AP, a third frame indicating acceptance of the suggestion in response to the fourth frame.

An aspect of the disclosure provides a station (STA) for facilitating communication in a wireless network. The STA comprises a memory and a processor coupled to the memory. The processor is configured to cause receiving, from an access point (AP) that is associated with the STA, a first frame that allocates a first resource unit (RU) for low-latency traffic transmission. The processor is further configured to cause determining whether the first RU is available or unavailable for preemption. The processor is further configured to cause transmitting low-latency traffic via the first RU without delay based on the determination that the first RU is available for preemption.

In an embodiment, the processor is further configured to cause abstaining from transmitting, to the AP, the low-latency traffic for a predetermined period based on a determination that the first RU is unavailable for preemption.

In an embodiment, the first frame includes information indicating that the STA has high priority access to the first RU.

In an embodiment, the processor is further configured to cause transmitting, to the AP, a second frame requesting high priority access to the first RU for low-latency traffic transmission. The processor is further configured to cause receiving, from the AP, a third frame indicating acceptance of the request of the second frame.

In an embodiment, the first frame indicates a pre-scheduled length of an uplink frame. The processor is further configured to cause adding a length of padding so as to meet the pre-scheduled length of the uplink frame.

In an embodiment, the transmitting low-latency traffic via the first RU further comprises transmitting a frame including the low-latency traffic, wherein a preamble of the frame is boosted in power by a predetermined value.

In an embodiment, the first frame allocates two or more first RUs. The determining whether the first RU is available or unavailable for preemption further comprises determining whether one of the one or more first RUs is available or unavailable for preemption.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example scenario RTA traffic piggybacked on ongoing transmission using dedicated RU in accordance with an embodiment.

FIG. 5 shows an example scenario of an RU dedicated for RTA traffic being occupied by OBSS STAs when the RTA traffic arrives in accordance with an embodiment.

FIG. 6 shows an example frame exchange for RTA traffic in a downlink case in accordance with an embodiment.

FIG. 7 shows an example transmission of a supporting STA (AP) transmitting PSDU in the reserved RU in accordance with an embodiment.

FIG. 8 shows an example frame exchange featuring preemption in an uplink transmission in accordance with an embodiment.

FIG. 9 shows an example periodic transmission in the LL RU with XIFS intervals in accordance with an embodiment.

FIG. 10 shows examples of LL traffic arrival and preemption in accordance with an embodiment.

FIG. 11 shows examples of LL traffic ending and the resulting state of the channel in accordance with an embodiment.

FIG. 12 shows an example negotiation procedure where the RTA STA initiates in accordance with an embodiment.

FIG. 13 shows an example negotiation procedure initiated by the AP in accordance with an embodiment.

FIG. 14 shows an example negotiation procedure between an RTA STA and supporting STA in accordance with an embodiment.

FIG. 15 shows an example multiple preemptions on two dedicated RUs in accordance with an embodiment.

FIG. 16 shows an example traffic-side process depicting the procedure for determining a channel to preempt in accordance with an embodiment.

FIG. 17 shows multiple preemption on one RU in accordance with an embodiment.

FIG. 18 shows an example supported STA-side process for preemption in accordance with an embodiment.

FIG. 19 shows an example supporting STA-side process for preemption negotiation in accordance with an embodiment.

FIG. 20 shows an example AP-side process for preemption negotiation in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

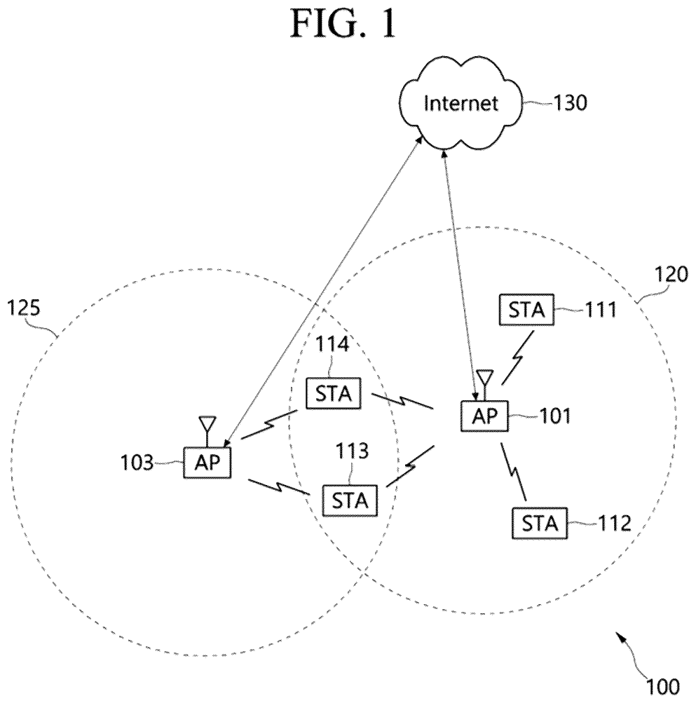

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

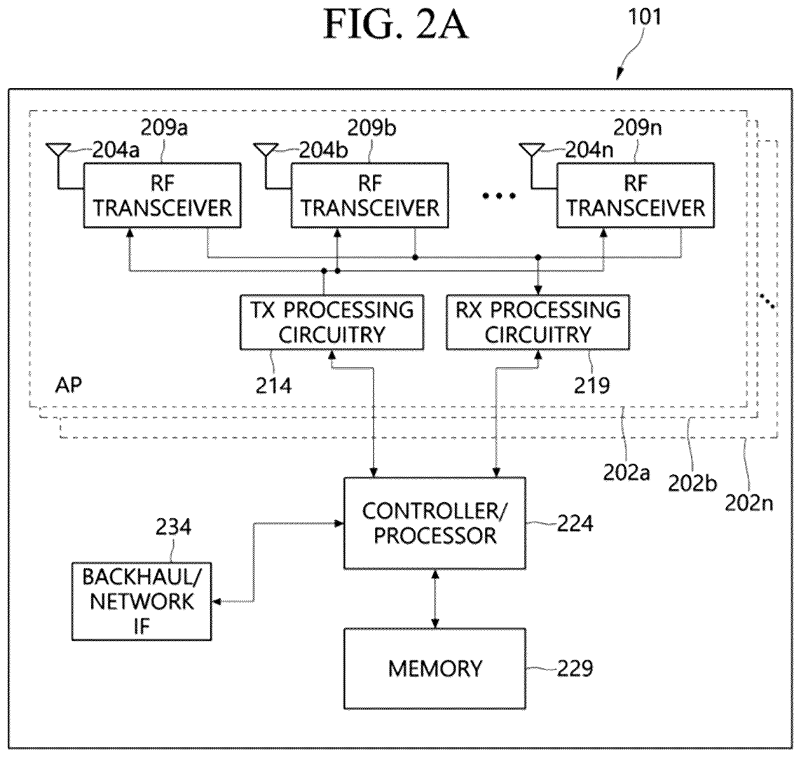

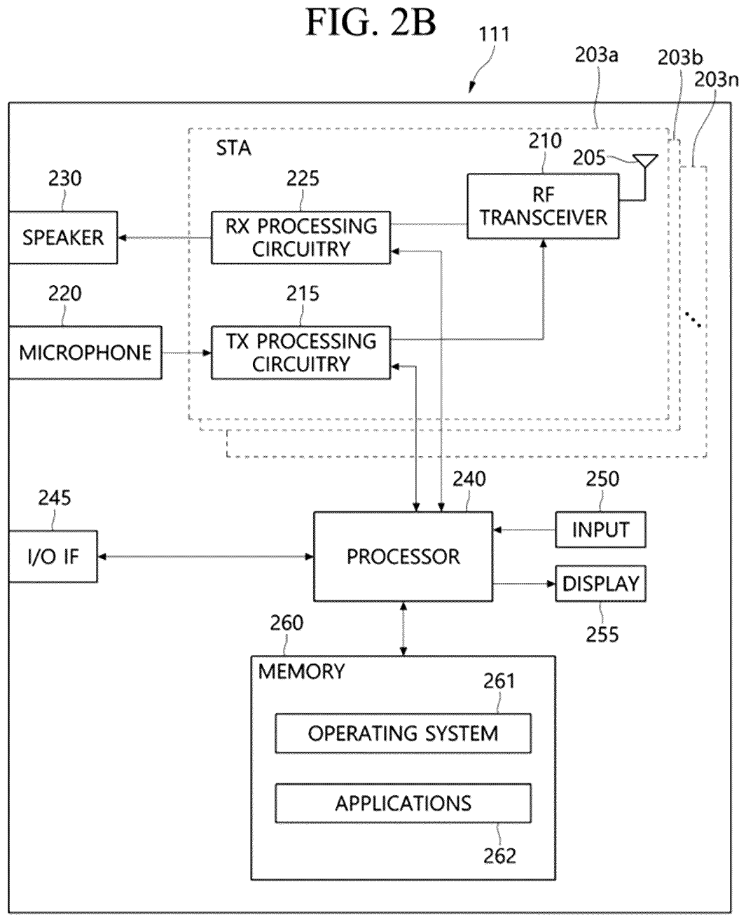

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

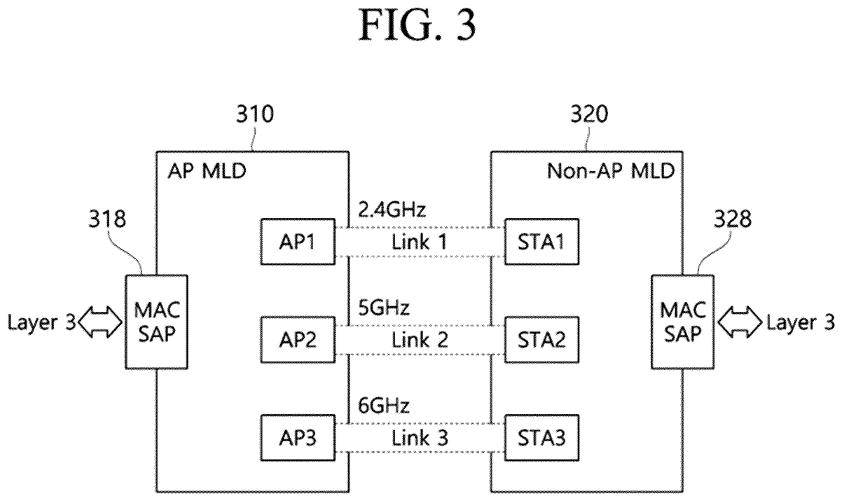

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Part 11: Wireless LAN Medium Access Control (MAC) and Physical Layer (PHY) Specifications—Amendment 8: Enhancements for extremely high throughput (EHT).”

In an infrastructure Wireless LAN network, a basic service set (BSS) typically refers to a network topology comprising an AP or an AP MLD, and all the non-AP devices associated with that AP or AP MLD. A BSS defines an operating bandwidth indicating the frequency resources that the devices belonging to the BSS may use for transmission, and rules on how the BSS devices may contend for the operating bandwidth. In particular, a Wireless LAN network BSS defines one of the 20 MHz channels of its operating bandwidth as the primary channel, and any device in that BSS is allowed to initiate transmission if the primary channel is sensed as IDLE after performing a required random back-off. The transmission is normally restricted to that primary 20 MHz and the duration of the transmission is called a transmit opportunity (TXOP) duration. However, if any non-primary channel of the BSS, such as a 20 MHz channel that lies within the operating bandwidth but is not the primary channel, is also sensed as IDLE for a priority interframe spacing (PIFS) duration before the time when the transmit opportunity starts on the primary channel for a Wireless LAN network device, the device man additionally also transmit on that non-primary channel. This mechanism is known as channel bonding and was further enhanced with the concept of preamble puncturing.

For any channel, primary or non-primary, a Wireless LAN network device has two channel sensing mechanisms to sense the channel state. The channel state is determined as being IDLE/BUSY. The first sensing mechanism is preamble detection where a Wireless LAN network device determines a 20 MHz channel as being BUSY if it can successfully detect a Wireless LAN network preamble on that channel with a received power higher than −82 dBm. The second sensing mechanism is energy detection where a Wireless LAN network device determined a 20 MHZ channel as being BUSY if it senses any power on that channel with a received power higher than −62 dBm. A Wireless LAN network device determines a 20 MHz channel as IDLE when neither preamble detection nor energy detection determines the 20 MHz channel as BUSY.

Recently, in the discussions for the latest generation of WiFi standard, IEEE 802.11bn, significant focus has been given for the need to reduce the channel access delay for low-latency traffic required by real-time applications (RTAs). In fact, the approved PAR for IEEE 802.11bn intends to define at least one mode of operation capable of improving the tail of the latency distribution and jitter compared to Extremely High Throughput MAC/PHY operation. There is a need to reduce the low latency for the increasing demand of RTA in 11bn. Thus, more stringent requirements are needed to meet the demands of new applications, such as metaverse, augmented and virtual reality, robotics, industrial automation for industrial IoT, logistics and smart agriculture. Establishing lower latency will lead to better customer experience, particularly in the case of latency/jitter mattering. Low latency communication has become increasingly more important, becoming an essential building block for RTA. For example, some use cases require at least less than 5 ms for latency and 2 ms for jitter as shown in Table 1.

Table 1 shows characteristics of low latency traffic in use cases.

TABLE 1

| | Intra BSS | Jitter | | |
|---|---|---|---|---|
| | Latency | variance | Packet | Data rate |
| Use cases | [ms] | [ms] | loss | [Mbps] |
| Real-time | <5 | <2 | <0.1% | <1 |
| gaming | | | | |
| Cloud | <10 | <2 | Near- | <0.1 (Reverse |
| gaming | | | lossless | Link) >5 Mbps |
| | | | | (Forward link) |
| Real-time | <3~10 | <1~2.5 | Near- | 100~28,000 |
| video | | | lossless | |

The need to deliver low latency traffic as soon as possible to support RTA STAs stems from high delay negatively affecting the RTA traffic in current networks. For example, the ongoing PHY protocol data unit (PPDU) may reach its maximum duration, such as the aPPDUMaxTime lasts 5.484 ms. This could severely delay the earliest time the low latency traffic may be delivered if the RTA traffic does not successfully contend for the channel.

To improve the delivery of low latency traffic, preemption is discussed in 11bn. Preemption in Wi-Fi may refer to the act of forcibly removing a traffic stream in progress to free up resources for another higher precedence traffic stream. The preemption could be performed with a PPDU, a TXOP or within both a time and frequency resource unit. A PPDU may be used in preemption by stopping another PPDU and allowing the delivery of the low latency (LL) traffic in its place. A TXOP may be used in preemption by interrupting the next PPDU to allow delivery of the LL traffic. Preemption may be performed within both time and frequency resource unit by inserting the LL traffic in the ongoing traffic via the parallel frequency resource.

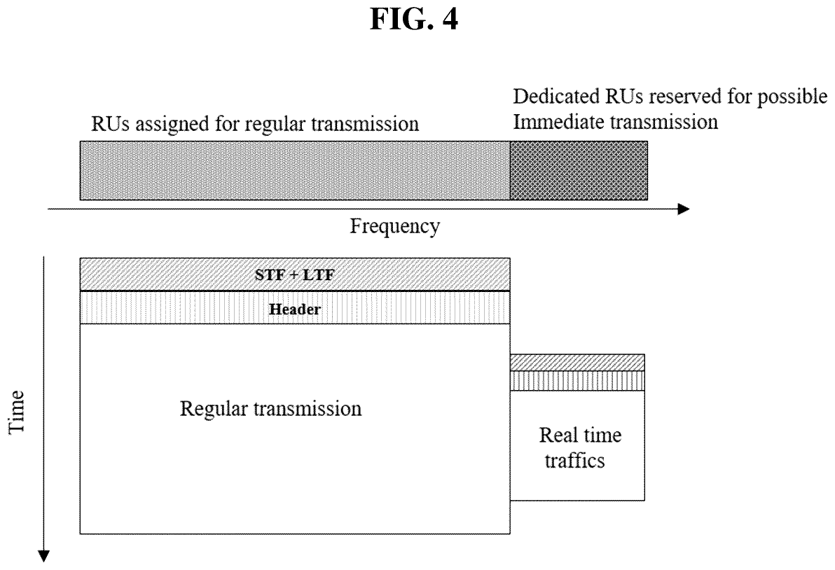

The preemption in time-frequency resource unit (RU) provides an opportunity that the RTA traffic may piggyback on the ongoing regular traffic to reduce the low latency. For example, to arrange and transmit the enqueued RTA traffic without waiting until after the transmission of an ongoing PPDU, the RTA traffic may attach to the ongoing PPDU by using any pre-determined dedicated RUs as shown in FIG. 4.

FIG. 4 shows an example scenario RTA traffic piggybacked on ongoing transmission using dedicated RU in accordance with an embodiment. The scenario depicted in FIG. 4 is for explanatory and illustration purposes. FIG. 4 does not limit the scope of this disclosure to any particular implementation.

Referring to FIG. 4, the top of the figure represents the frequency transmission with the left side of the frequency transmission comprising RUs assigned for regular transmission and the right side of the frequency transmission comprising dedicated RUs reserved for possible immediate transmission. The bottom of the figure represents the time transmission with the left side of the time transmission comprising a short training field (STF) and a long training field (LTF), a header and the regular transmission and the right side of the time transmission comprising the RTA traffic.

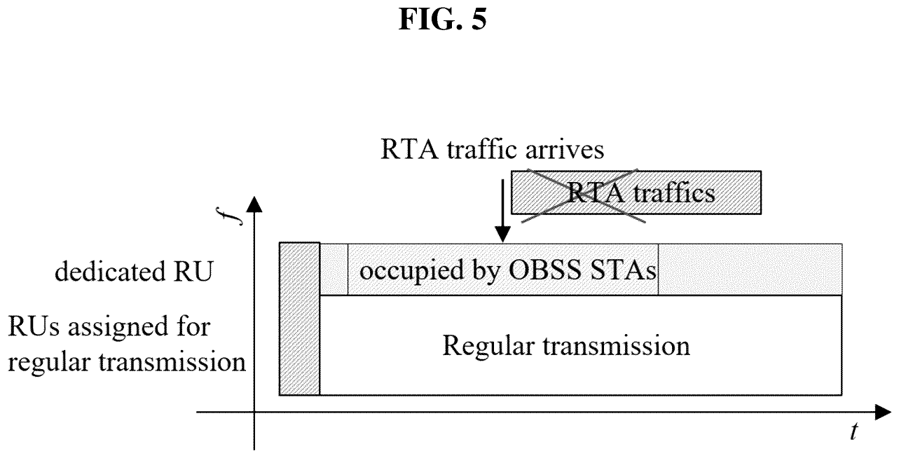

The dedicated RUs provide a solution to the delivery of low latency traffic, but other non-RTA traffic may occupy the RUs. The dedicated RUs may be occupied by other STAs which may not be aware of the reservation of the RUs for the RTAs when the RTA traffic arrives. This may occur when no signal is transmitted on the dedicated RUs during a period of time in which the RTA sees that the RU is idle but before the RTA traffic arrives in the buffer. Such STAs may be Overlapping Basic Service Set (OBSS) STAs or legacy devices that may lack the capacity to recognize that the RU is reserved for RTA traffic. OBSS STAs may observe the dedicated RUs as being idle and use them in their own transmissions as a result of channel bonding and preamble puncturing. This is highly likely to occur because BSS generally perform transmissions out of synchronization, performing inter-BSS backoff using energy detection instead of preamble detection. With energy detection, a neighboring BSS cannot set the network allocation vector (NAV) for the transmission and thus may take up the idle 20 MHz channel that was reserved for RTA traffic as shown in FIG. 5.

FIG. 5 shows an example scenario of an RU dedicated for RTA traffic being occupied by OBSS STAs when the RTA traffic arrives in accordance with an embodiment. The scenario depicted in FIG. 5 is for explanatory and illustration purposes. FIG. 5 does not limit the scope of this disclosure to any particular implementation.

Referring to FIG. 5, a time and frequency resource unit comprises RUs assigned for regular transmission in the lower half of the time and frequency resource unit and a dedicated RU reserved for RTA traffic in the top half of the time and frequency resource unit. The dedicated RU is occupied by OBSS STAs when the RTA traffic arrives resulting in latency for the RTA traffic.

Additionally, the RTA traffic is aperiodic and non-predictable, so if the reserved RU is not used by the RTA traffic, it could be wasted. Therefore, to avoid OBSS STAs taking the dedicated RU from the RTA traffic and to avoid the dedicated RU from being wasted if no RTA traffic arrives, solutions are needed to protect the dedicated RU and prevent wasting.

In an embodiment, a Wireless LAN network device, such as an AP, may reserve a portion of that bandwidth for transmission of low-latency traffic to RTA devices after successfully contending for the channel for a specific transmit bandwidth. This reservation may be for transmission to the RTA STAs. This reservation may also be for reception from the RTA STAs. This portion of the bandwidth may be non-contiguous and may include multiple RUs called, for example, LL RUs.

In an embodiment, a TXOP initiator may transmit a frame providing signaling of LL RUs in a TXOP obtained by the TXOP initiator. This frame may be a trigger frame or a multi-user (MU) PPDU. The signaling of the LL RUs may be carried in a special User Info field of the trigger frame or the high efficiency (HE)-signal (SIG)-B field of the MU PPDU. A specific RU of a BSS operating bandwidth may be subject to a long-term reservation as a LL RU. A device, such as an AP, may provide an indication that the specific RU is subject to the long-term reservation as a LL RU. The AP may provide this indication in its beacons, probe response and/or association response frames.

The RTA STAs which intend to use the LL RUs for low-latency transmissions may be referred to as supported STAs. The supported STAs may be the TXOP owner itself or may be any other RTA STA, such as the case of triggered uplink TXOP. The low latency traffic buffer may not be able to initiate transmission of low-latency traffic on the dedicated LL RUs at the beginning of the TXOP when the low-latency traffic buffer is empty at the beginning of the supported STA's TXOP. The LL RUs may be reserved by other STAs who support the LL traffic from the RTA STA to prevent OBSS STAs from detecting the LL RUs as being IDLE. These other STA may be referred to as supporting STAs. The AP may be the supporting STA by scheduling any PPDUs to reserve the dedicated LL RUs in a downlink case. The AP may request that an STA act as a supporting STA to transmit PPDUs on the LL RUs to “occupy a seat” for potential RTA traffic in an uplink case.

Supporting STAs may be able to vacate the LL RU for use by a supported STA as soon as possible when one or more RTA traffic arrives in queue from one or more supported STAs. This procedure for vacating and releasing the LL RU and the use of the LL RU by the supported STA may be called preemption.

In an embodiment, the supporting STA may follow rules described in the following paragraph. The supporting STA may be aware of the channel (LL RU) which is reserved for RTA traffic. The supporting STA may help to reserve the LL RU by transmitting, for example, PPDUs or null data packet (NDP) frames. The supporting STA may help to reserve the LL RU by receiving, for example, PPDUs or NDP frames. The supporting STA may be an AP transmitting on the dedicated RU. The supporting STA may also be a non-AP STA receiving the data from the dedicated RU. The supporting STA may be a non-AP STA that is appointed by an AP or a supported STA. The supporting STA may be preempted by the LL traffic during the gap duration, which may be referred to as XIFS.

In an embodiment, the supported STA may follow the rules described in the following paragraph. The supported STA may have low latency traffic and may be aware of the dedicated channel (LL RU). The supported STA may take the dedicated LL RU and preempt during the gap duration, XIFS. The supported STA may be an AP or a non-AP STA that may have LL/RTA traffic requests during ongoing transmission. The supported STA may be a non-AP STA that was indicated in the beginning of a TXOP to be eligible for RTA transmissions during the TXOP.

In an embodiment, the AP may be a supporting STA to schedule one or more PPDUs or PHY service data units (PSDUs) or medium access control (MAC) service data units (MSDUs) on the dedicated RU, until the RTA traffic arrives and the prior PPDU or PSDU or MSDU is ended.

In an embodiment, the AP may be a supporting STA to schedule any length of the PPDU or PSDU or MSDU on the dedicated RU with the provisioning of some intermediary transmission intervals, which may be of a predetermined length such as short inter frame space (SIFS), or the new duration XIFS.

In an embodiment, XIFS may be a time interval between the frame transmitted by the supporting STA.

In an embodiment, the AP may appoint an STA or negotiate with an STA to be a supporting STA, in which the STA may transmit a contiguous PPDU or PSDU or MSDU, or any length of the PPDU or PSDU or MSDU on the dedicated RU.

In an embodiment, an STA that may be a supporting STA may indicate its capability of becoming a supporting STA. Additional details are also considered in the negotiation procedure addressed below.

In an alternative embodiment, multi-AP coordination may be used. The associated AP may notify all the STAs around to avoid using the reserved channel. Some STAs may be the potential OBSS STAs to the low latency RTA traffic.

In an alternative embodiment, the traffic may be reserved with a dedicated link in multi-link operation.

An AP may be the supporting STA to reserve the channel by transmitting PSDU or PPDU or MSDU frames, in the dedicated LL RU, to an STA1. STA1 may also be the supporting STA to receive the PSDU or PPDU or MSDU in the dedicated LL RU. In an embodiment, the AP may transmit null frames on the LL RU to keep it reserved if no such STA1 exists. At the same time, in the other RUs, AP may also schedule regular transmission for an STA2 if there is a need.

The supporting STA (AP) transmits a PSDU in the reserved RU to STA1 when downlink RTA traffic has not arrived for an STA3. The AP may end the current transmission on the dedicated RU and schedule the RTA traffic as soon as possible, when the RTA traffic arrives at any time of the ongoing PPDUs. STA1 and the RTA STA, STA3, may share the same dedicated RU in different time. In an embodiment, the AP may transmit null frames on the LL RU periodically or dynamically if no STA1 exists. An STA, such as an RTA STA, may be able to determine that the medium is idle through the use of the preamble detection for the interval specified if periodically transmitting frames with a specified interval such as SIFS or XIFS.

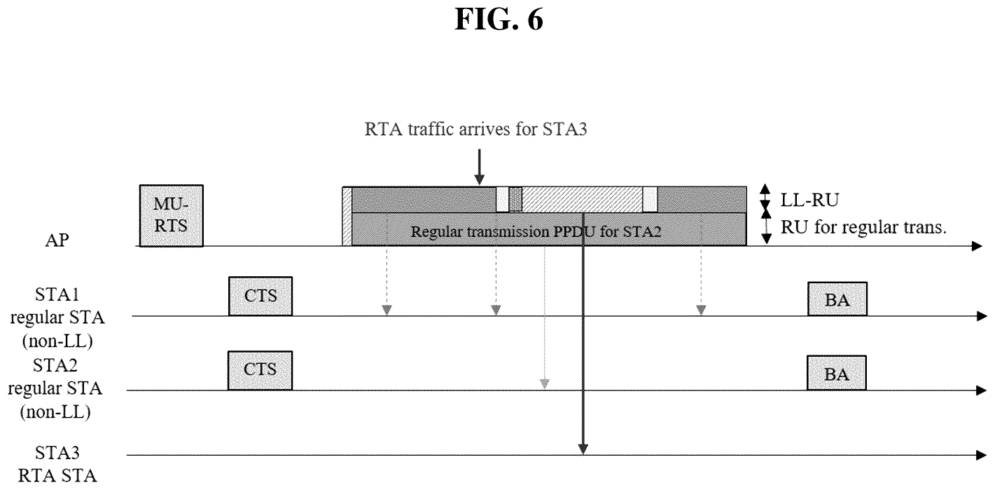

FIG. 6 shows an example frame exchange for RTA traffic in a downlink case in accordance with an embodiment. The frame exchange depicted in FIG. 6 is for explanatory and illustration purposes. FIG. 6 does not limit the scope of this disclosure to any particular implementation.

Referring to FIG. 6, there is an AP engaged in frame exchanges with two regular STAs non-LL), STA1 and STA2, and an RTA STA, STA3. The AP transmits a multiuser request to send (MU-RTS) triggered TXOP sharing (TXS) Trigger frame to STA1 and STA2. In response, STA1 and STA2 transmit a clear to send (CTS). The AP begins transmitting regular transmission PPDU for STA2 on the RU for regular transmissions and transmitting PPDU on the LL RU for STA1. The RTA traffic arrives on the queue for STA3 during the transmission for STA1. Subsequently, the AP ends the transmission for STA1 and begins transmission of the RTA traffic for STA3. After the transmission of the RTA traffic for STA3 is complete, the AP resumes the transmission for STA1 on the LL RU. In response, after completion of both the transmission for STA1 and the transmission for STA2, STA1 and STA2 each transmit a block acknowledgement to the AP.

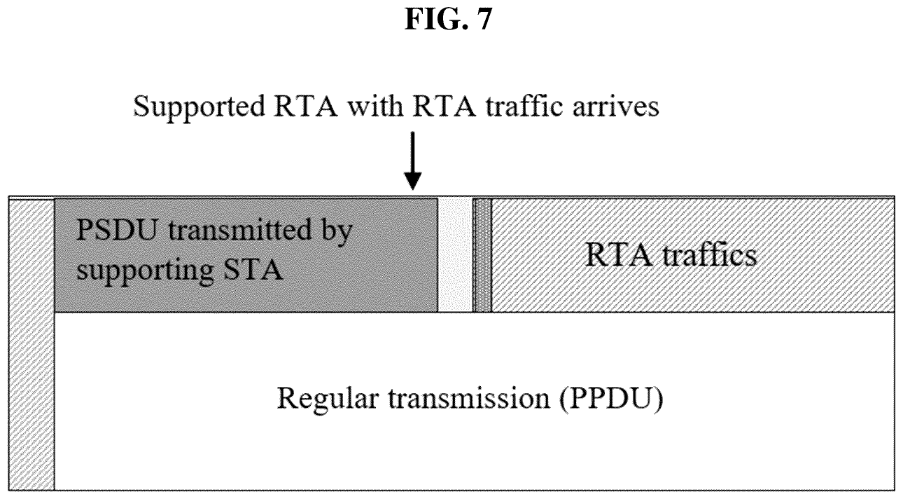

In an embodiment, the RTA traffic may be piggybacked upon a mid-amble of the regular transmission PPDU for STA2. In an embodiment, the RTA traffic may be scheduled through a delimiter of the regular transmission MPDU for STA2. In an embodiment, the AP may end the current transmission and schedule the RTA traffic right away if there is no STA2. In an embodiment, the RTA traffic may also take the whole RU and the rest of the TXOP by transmitting enough data or adding paddings until the end of the traffic, as shown in FIG. 7. According to an embodiment, the AP may dynamically update the transmission based on the traffic flow in AP's buffer for downlink communication.

FIG. 7 shows an example transmission of a supporting STA (AP) transmitting PSDU in the reserved RU in accordance with an embodiment. The transmission depicted in FIG. 7 is for explanatory and illustration purposes. FIG. 7 does not limit the scope of this disclosure to any particular implementation.

Referring to FIG. 7, the regular transmission comprises a PPDU and the reserved RU is being used by a supporting STA until RTA traffic of the supported STA arrives. The supporting STA transmitted PSDU prior to the arrival of the RTA traffic. The PSDU transmission for the supporting STA is halted after the RTA traffic arrives and the transmission of the RTA traffic continues until the end of the transmission.

A supporting STA (AP) transmitting on LL RU may follow the behavior described in the following paragraph. The AP may be the supporting STA to reserve the RU by transmitting the data. The AP may need to transmit any frames in the dedicated RU. The AP may need to monitor its buffer during the TXOP. The AP may need to stop its downlink non-LL transmission if the LL traffic, such as RTA traffic, arrives. The AP may schedule the LL traffic to a supported STA and indicate the LL traffic information in the preamble so that the supported STA may be detected. The AP may need to indicate the LL RU and BW to the supported STA. In an embodiment, the AP may need to indicate the LL RU and BW to a supporting STA that may receive the data and to a supported STA.

A supporting STA receiving on LL RU may follow the behavior described in the following paragraph. The supporting STA may need to receive the frames in the dedicated RU from the supporting STA (AP) that transmits on the dedicated RU. The supporting STA may not have to receive the frames if it declines its capability to be a supporting STA as a receiver STA. The supporting STA may need to be aware of an interruption of the current transmission. The supporting STA may also be aware of errors or different RA from the current ongoing transmission.

A supported STA may follow the behavior described in the following paragraph. The RTA STA may need to keep monitoring the dedicated RU. The RTA STA may detect the LL preamble and receive the LL data during the TXOP.

Other STAs associated with the AP may follow the behavior described in the following paragraph. The other STAs may or may not be aware of the LL RU. The other STAs may need to avoid any transmission on the LL RU channel during the TXOP/TWT if they are aware of the LL RU indication information.

In an embodiment, the AP may indicate the LL RUs and supporting STA in the trigger frame such as MU-RTS trigger frame.

In an embodiment, there may be a special User Info field, such as with a new AID12, for those who may use LL RU(s). This User Info field may also indicate the AID12 of the supporting STA, such as STA1.

In an embodiment, there may be a special user info field, such as with a new AID12, for indicating LL RU(s). There may be another User Info field corresponding to the AID12 field of the supporting STA where the same LL RU is assigned. The RU allocation of the User Info field may be the same for the supporting STA and supported STA.

In an embodiment, there may be a field for indicating that the RU allocation may be preempted during the TXOP, for example, if there is no such STA1 and AP may transmit the null frames periodically.

In an embodiment, the supporting STA may be the legacy non-LL STA using the AID12 subfield number from 1-2007. The RU allocation and bandwidth (BW) may be the same as dedicated LL RU. In an embodiment, the RTA STA may be assigned a special User Info field. An example encoding is shown in Table 2, in which if 2008 is encoded for associated latency sensitive STA while 2047 is encoded for unassociated latency sensitive STA. One of the 1-2007 can be assigned for the supporting STA who may receive the PSDU, and the RU and BW may need to be the same as those of the associated latency sensitive STA or the unassociated latency sensitive STA.

Table 2 shows a Modified Table 9-29h featuring an AID12 subfield encoding

TABLE 2

| AID12 subfield | Description |
|---|---|
| 2008 | User Info field allocates on or more contiguous |
| | dedicated RUs for associated latency sensitive STAs |
| 2047 | User Info field allocates one or more contiguous |
| | dedicated RUs for unassociated latency sensitive STAs |
| 1-2007 | For supporting STA appointed by AP (RU and BW need |
| | to be aligned with that of either 2008 or 2047) |

In Table 2, “2008” and “2047” are used in the AID12 subfield, however, other reserved bits may be used. “2008” may be any reserved bit within 2008-2044. “2047” may be any reserved bit within 2047-4094. The unassociated latency sensitive STA may transmit frames, such as (re) association and authentication frames.

In an embodiment, any STA that has traffic qualified as RTA traffic may be served on the LL RUs of a TXOP, such STAs may all be supported STAs of the TXOP.

In an embodiment, the AP may provide an indication of the RTA STAs which are eligible to be supported STAs during the LL RUs of a TXOP. This indication of supported STAs may be a long-term indication, such as in a beacon frame or in a stream classification service (SCS) frame, and that is applicable until the next beacon frame or SCS frame. The indication may instead be a per-TXOP indication that is present at the beginning of the TXOP initiated by the AP. The supported STAs may, for example and without limitation, be indicated by carrying User Info fields corresponding to each of the AIDs of the supported STAs in the MU PPDU that initiates the TXOP. The RU Allocation field of the User Info field may carry the LL RU indication. There may be a separate field in this User Info Field to indicate that the allocation is for pre-empted RTA traffic which may arrive in the middle of the PPDU. The separate field may, for example and without limitation, include the RTA's AID12, one bit for a Preempted RTA traffic field. The RTA traffic may arrive in the middle of the PPDU when the Preempted RTA traffic field is set to 1. The RTA traffic may not be able to arrive in the middle instead of in the beginning or a specific position of the ongoing PPDU when the Preempted RTA traffic field is set to zero.

There may be a special User Info field with the AID12 field set to a special reserved value for indicating the RU allocation for low-latency traffic. In the body of that User Info field, there may be a limited number of additional AID12 fields that are used to identify the supported STAs. The indicated supported STAs may be required to monitor the LL RUs for the duration of the TXOP to determine if an RTA transmission is initiated for them.

In an embodiment, the AP may choose a BW and a RU and announce or broadcast the RU as a dedicated RU. In an embodiment, STA1, that also supports the LL STA by receiving the PSDU from the AP, may transmit a clear-to-send (CTS) indicating an agreement to receiving on the dedicated RU. STA1 may be aware of the interruption when ceasing to receive transmission from the AP after the AP begins regular transmission and abruptly transmits LL traffic to STA3. STA1 may be considered to agree with the interruption caused by the RTA STA according to its response in transmitting the CTS.

The preamble may be subject to PHY considerations as described in the following paragraph. The LL preamble or MAC header may be simple, only indicating the arrival of the traffic, such as LL traffic and the RTA traffic. The PHY header may be the same for both the regular transmission to other STAs in other RUs and to the reserved RU for the supporting STA. The preamble of the LL RTA traffic may be designed as a new short preamble which may indicate the LL traffic as being ultra-high reliability (UHR), for example using UHR-signal (SIG).

In an embodiment, there may be a restriction on the LL RU allocations.

In an embodiment, only one LL RU reservation may be allowed per TXOP.

In an embodiment, only one RTA traffic from one RTA STA is allowed per TXOP.

In an embodiment, the LL RUs may need to be contiguous in frequency. In another embodiment any two LL RUs must be separated from each other by at least a minimum bandwidth or a minimum duration.

In an embodiment, each LL RU may occupy a minimum required bandwidth, such as 20 MHz. This bandwidth limit may be present to ensure successful and quick detection of the low-latency transmissions within the LL RU can be done. In another embodiment, each LL RU may have a maximum allowed bandwidth, such as less than 20 MHz. The maximum allowed bandwidth may be present to limit the chance of the reserved RUs being detected as idle by a neighboring BSS.

In an embodiment, there may be a restriction on the channels which are used for the LL RUs, such as the primary channel of the BSS may not be used as a LL RU channel. Another restriction may be that the primary channel of neighboring OBSSs may not be used as the LL RU channel. Another restriction may be that the primary channel of neighboring OBSSs may be used as the LL RU channels.

In an embodiment, the LL RU may not be assigned to other STAs that are not a supporting STA or a supported STA.

In an embodiment, some of these constraints may be specifically applicable for uplink transmissions or specifically applicable for downlink transmissions.

In an embodiment, the LL RU may be extended or considered as a link of the multi-link operation.

In an embodiment, there may also be a restriction on the types of devices that are allowed to make LL RU allocations. Such a restriction may be that only APs, or only STAs that are capable of multi-channel preamble detection, may be allowed to allocate LL RUs.

An AP may need to appoint an STA as a supporting STA to reserve the channel by transmitting PSDU or PPDU or MSDU in the dedicated LL RU in uplink transmission. The supporting STA may transmit data with a predefined length and with intervals of duration XIFS. The RTA traffic may preempt the ongoing traffic during these XIFS intervals. Simultaneously, on the other RUs, the AP may also allow regular uplink transmission from another STA if there is a need.

The supporting STA may transmit frames or zero padded frames of NDP frames on the dedicated LL RUs with a pre-defined packet length and a preemptable interval, such as XIFS, when RTA traffic has not arrived yet. In an embodiment, the supported STA may preempt during the coming XIFS and end its uplink transmission before any next preemptable interval starts when the RTA traffic arrives during the ongoing traffic of the supporting STA. In an embodiment, the supporting STA may keep its uplink transmission if it detects the dedicated RU is idle.

In an embodiment, the supporting STA may resume reserving the channel again until the end of the TXOP or until another supported STA preempts it after the end of the transmission of the low latency traffic by a supported STA via preemption on the LL RU. The supporting STA may take opportunities to transmit its traffic during the LL RU. The supported STA with LL traffic may find the channel reliably reserved for its use. In an embodiment, the RTA traffic may take the rest of the TXOP by continuously transmitting LL traffic or paddings.

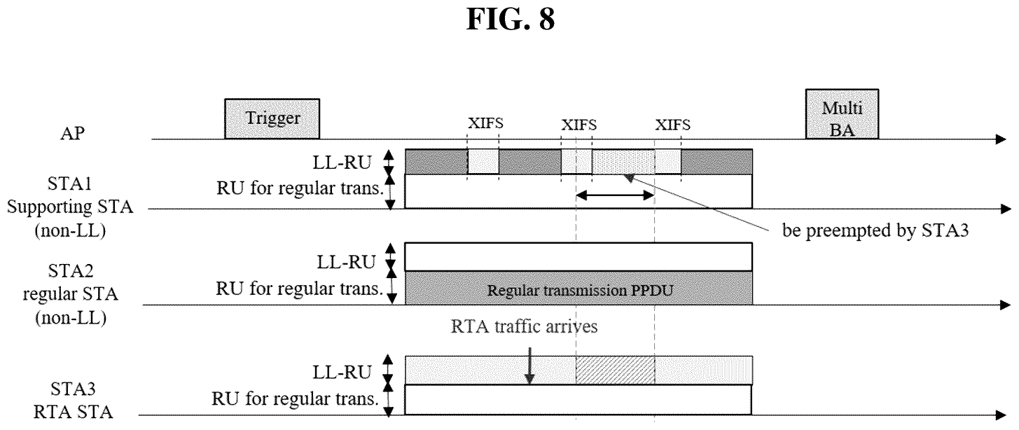

FIG. 8 shows an example frame exchange featuring preemption in an uplink transmission in accordance with an embodiment. The frame exchange depicted in FIG. 8 is for explanatory and illustration purposes. FIG. 8 does not limit the scope of this disclosure to any particular implementation.

Referring to FIG. 8, the AP transmits a trigger frame allocating TXOP to STA1, STA2 and STA3. STA1 is a supporting STA (non-LL) that transmits periodic traffic on the LL RU with XIFS intervals. STA1 is preempted by STA3 during the second XIFS interval and resumes its periodic transmission after the third XIFS interval. STA2 performs regular (non-LL) transmission on the RU for regular transmission. STA3's RTA traffic arrives on the LL RU during STA1's transmission. Subsequently, during the next XIFS interval, STA3 successfully preempts STA1 and transmits RTA traffic. Following the end of the TXOP, the AP receives, from STA1, STA2 and STA3, block acknowledgements (BAs).

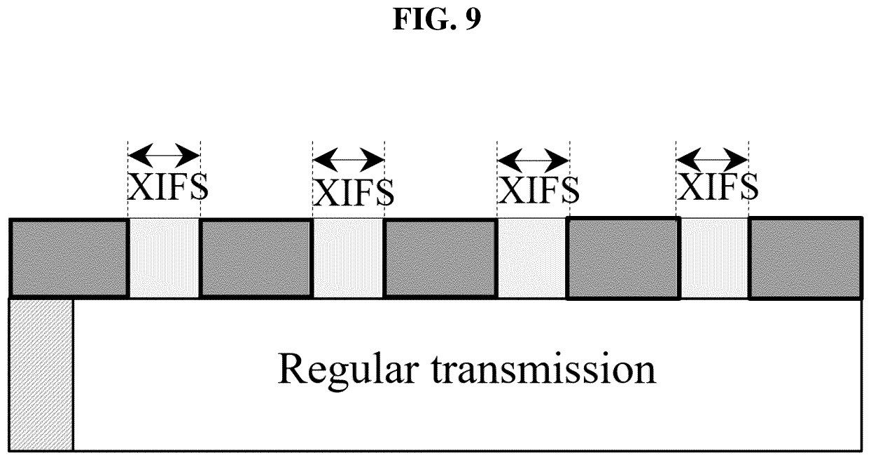

FIG. 9 shows an example periodic transmission in the LL RU with XIFS intervals in accordance with an embodiment. The periodic transmission depicted in FIG. 9 is for explanatory and illustration purposes. FIG. 9 does not limit the scope of this disclosure to any particular implementation.

Referring to FIG. 9, the RU for regular transmission is depicted on the lower half of the channel and the LL RU is depicted on the upper half of the channel. The LL RU is in use by a supporting STA where the supporting STA transmits periodic traffic with a XIFS interval. A supported STA may preempt the supporting STA's transmission during any XIFS interval.

In an embodiment, XIFS is the duration allowing preemption. The duration of XIFS may consider the time of clear channel assessment (CCA). The duration of XIFS may also need to be shorter than SIFS which is the shortest duration between transmissions from different STAs. The XIFS time may need to provide enough time for the CCA to satisfy the energy detection. According to 17.3.10.6, an STA may use carrier sense (CS)/CCA to detect if a channel is busy with a probability more than 90% within 4 us for 20 MHz channel spacing and 8 us for 10 MHZ channel spacing. The length of SIFS is 10 us in 2.4 GHz and 16 us in 5 GHZ (ac, ax). Thus, the XIFS may need to be greater than at least 4 μs. In another embodiment, XIFS may also be SIFS allowing preemption, and the priority interframe space (PIFS) may be considered for longer frame exchanges.

In an embodiment, the supporting STA may identify the start of the RTA traffic during any of the XIFS intervals (and thus determine a need to stop transmission) using only energy detection. In another embodiment, the supporting STA may also use preamble detection to identify the start of RTA traffic during any XIFS interval. The preamble detection may involve identification of the conventional PHY preambles, or the identification of a new shorter preamble that is used by the supported STAs to initiate their RTA transmissions. This shorter preamble may be referred to as low latency preamble.

In an embodiment, the supported STA that has uplink RTA traffic may initiate transmission immediately after the start of the XIFS interval. In another embodiment, the supported STA may wait for a short pre-determined interval from the start of the XIFS interval to initiate uplink RTA data transmission. The XIFS interval may be to allow the supporting STA to have sufficient time to switch from transmit or receive mode to listen operation. In one embodiment, the supported STA may initiate the RTA traffic with a conventional PHY preamble. In another embodiment, a new low latency preamble may be designed for transmission by the supported STA during the preemption. This new low latency preamble design may be shorter in length and may have a different signature to prevent legacy devices from suffering from a frame capture issue.

A supporting STA (AP) receiving on LL RU may follow the behavior described in the following paragraph. The AP may need to appoint a supporting STA in the trigger frame. The AP may need to indicate the LL RU, BW, preemption information, transmission patterns to supporting STA and supported STA. In an embodiment, the AP may broadcast the LL RU information to indicate to other STAs associated with the AP not to use it.

A supporting STA transmitting on LL RU may follow the behavior described in the following paragraph. The supporting STA may need to transmit any uplink data to the AP to reserve the RU. The supporting STA may need to monitor the channel during the XIFS intervals. The supporting STA may need to stop its uplink transmission if any of the LL traffic preempts. The supporting STA may need to continue its uplink transmission to reserve the channel after the preemption if it observes the channel as idle.

A supported STA may follow the behavior described in the following paragraph. An RTA STA that is indicated as the supported STA may need to transmit in the dedicated RU that the AP indicated in the trigger frame. The supported STA may need to monitor the dedicated RU during the TXOP. The supported STA may schedule its LL traffic right away, if the LL traffic is arriving and the supported STA senses that the channel is idle. The supported STA may wait until the next XIFS interval in which the channel is idle again if the supported STA senses that the channel is busy.

Other STAs associated with the AP may follow the behavior described in the following paragraph. The other STAs may be aware of the LL RU and avoid any transmission on this channel during the TXOP/target wake time (TWT).

In an embodiment, the LL traffic may start in one or more of three cases. The LL traffic may start before the whole transmission. The LL traffic may start in the middle of the PPDU that supporting STA is transmitting. The LL traffic may start during the XIFS. Specifically, the supporting STA (AP) may schedule the LL traffic right away when the traffic arrives before the whole transmission. The supporting STA may preempt within the XIFS interval before the next PPDU when the LL traffic arrives in the middle of the reserved PPDU transmitted by the supporting STA. The supported STA may still have the opportunity to successfully contend for the channel when the LL traffic arrives during the XIFS interval and there is enough time in the interval remaining for the supporting STA and other LL STAs to perform CCA before the next PPDU. The time in the interval remaining, such as t, may be at least greater than 4 μs. In an embodiment, the supported STA may wait until the next XIFS if there is not enough time for CCA.

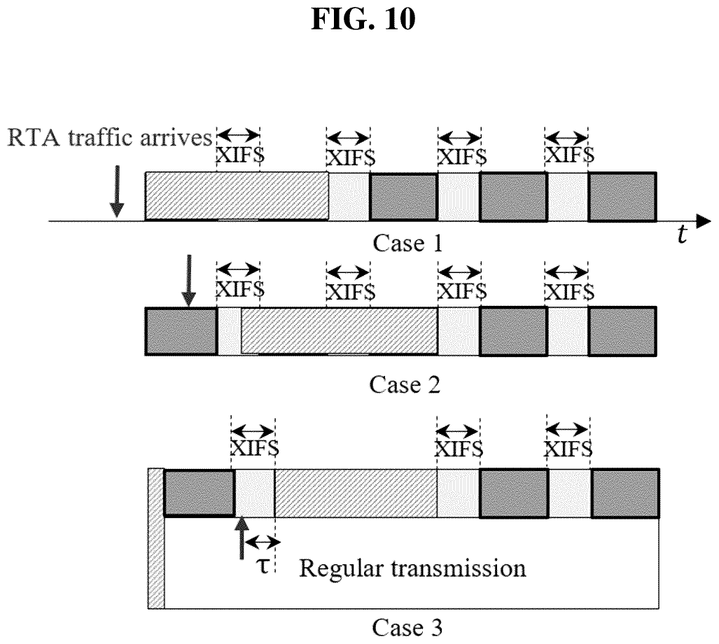

FIG. 10 shows examples of LL traffic arrival and preemption in accordance with an embodiment. The LL traffic arrival and preemption depicted in FIG. 10 is for explanatory and illustration purposes. FIG. 10 does not limit the scope of this disclosure to any particular implementation.

Referring to FIG. 10, case 1 shows preemption when the RTA traffic arrives before the whole transmission. In case 1, the RTA traffic is immediately scheduled. Case 2 shows preemption when the RTA traffic arrives in the middle of the reserved PPDU transmitted by the supporting STA. In case 2, the RTA traffic preempts before the next PPDU within the XIFS interval. Case 3 shows preemption when the RTA traffic arrives during the XIFS interval. In case 3, the RTA traffic will preempt if there is still enough time t in the XIFS interval and will otherwise wait until the next XIFS interval.

In an embodiment, the LL traffic may end in one of three cases. In one embodiment, the supported STA may adjust the length of the PPDU by adding paddings to fill the scheduled pattern. The first case involves the LL traffic ending right at the pre-scheduled packet length providing the whole XIFS interval. The first case is optimal, and the supporting STA continues to transmit the reserved PPDUs/PSDUs. The second case involves the LL traffic ending during the XIFS interval before the next reserved PPDU/PSDU. There may be too little time left in the XIFS interval for preemption and/or CCA for other STAs if the LL traffic spends more time during the XIFS. The supported STA may add paddings until the end of the scheduled PPDU when there is not enough time left in the XIFS interval for preemption or CCA for other STAs. The third case involves the LL traffic ending before the reserved PPDU would have ended if not preempted. This may cause a channel to be vacant/idle for the period until the next reserved PPDU, longer than the XIFS interval, during which time another STA, such as an OBSS STA, may steal the channel. In particular, the risk of an OBSS STA stealing the channel is dangerously high if the time τ+XIFS is greater than SIFS. To avoid this, the supported STA may add paddings to fill the pre-defined PPDU length.

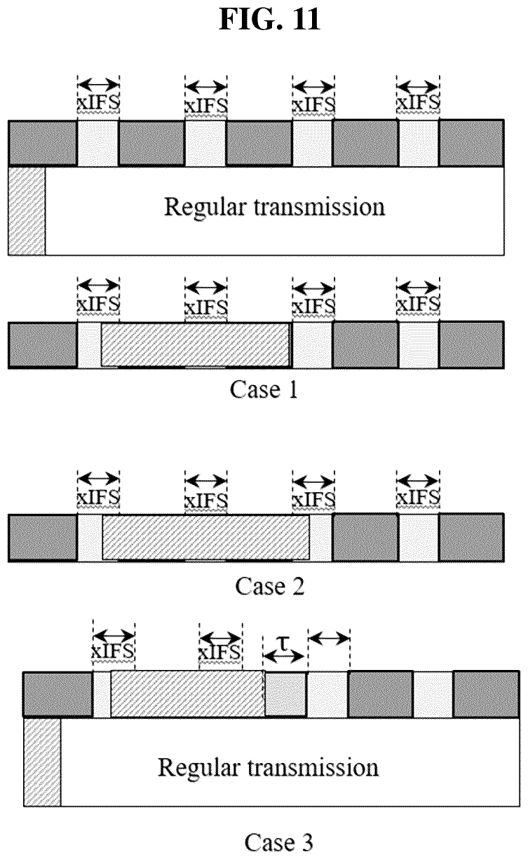

FIG. 11 shows examples of LL traffic ending and the resulting state of the channel in accordance with an embodiment. The LL traffic ending and resulting state of the channel depicted in FIG. 11 is for explanatory and illustration purposes. FIG. 11 does not limit the scope of this disclosure to any particular implementation.

Referring to FIG. 11, case 1 shows the state of the channel when the LL traffic ends right at the end of the pre-scheduled packet length. In case 1, the channel continues to be used by the supporting STA without interruption and the whole XIFS interval is available for other LL traffic needs. Case 2 shows the state of the channel when the LL traffic ends during the XIFS interval. In case 2, the channel continues to be used by the supporting STA without interruption but there may be insufficient time for other LL traffic needs. Case 3 shows the state of the channel when the LL traffic ends before the reserved PPDU. In case 3, the channel is idle for a time that may be long enough for an OBSS STA to steal the channel and so the LL traffic may add padding to prevent such an event.

In an embodiment, the AP may indicate LL RUs and supporting STAs in the trigger frame, such as MU-RTS trigger frame.

In an embodiment, one or more of the supporting STAs assigned by the AP may help to reserve the LL RU by transmitting NDP or specific length PPDUs.

The concept and signaling of uplink orthogonal frequency division multiple access (OFDMA)-based random access (UORA) may be extended for the uplink design. The downlink signaling design may also be considered similarly.

In an embodiment, there may be a special user info field (with new AID12) for indicating LL RU. This LL RU may also indicate the AID12 of the supporting STA. The AID12 subfield encoding may be as shown in Table 3, in which 2008 is encoded for both associated latency sensitive STA and supporting STA.

In an embodiment, there may be a special user info field (with a new AID12) for indicating LL RU. There may be another User Info field corresponding to the AID12 field of the supporting STA where the same LL RU is assigned. Additionally, a bit in that User Info field may be used to indicate that the assignment is for low-latency, such that the LL RU should be preemptable.

Table 3 shows a modified Table 9-2 featuring an AID12 subfield encoding.

TABLE 3

| AID12 subfield | Description |
|---|---|
| 2008 | User Info field allocates one or more contiguous |
| | dedicated RUs for associated latency sensitive |
| | STAs and supporting STA. |

In an embodiment, the supporting STA and supported STA may be identified in the User Info field of the User Info List of the trigger frame with different AID, such as User Info field M for supported STA (LL STA) and User Info field N for supporting STA.

In an embodiment, the supporting STA may also be the legacy non-LL STA using the AID12 subfield number from 1-2007, while the BW and RU allocation may need to be the same as the supported STA assigned by AP.

The RU allocation of the User Info field format along with the uplink BW subfield in the Common Info field of the trigger frame identifies the size and the location of the RU. The RU may need to be greater than a limited size. For example and without limitation, the minimal dedicated RU may be 242 tones, and thus B7-B1 of the RU Allocation subfield may start from 61.

The dedicated RU information and the preemption information items such as the RU allocation information, length of XIFS, duration of each PPDU/PSDU/MSDU, and/or reserved start timestamp may need to be considered. Such information items are listed in Table 4. This information may be considered in the User Info field of the trigger frame. Both the supporting STA and supported STA may be aware of this preemption information. Thus, the supporting STA and supported STA may notice the preempting time, PSDU/PPDU/data ending time, and the time for resuming or doing paddings.

The LL preemption information field of the User Info field may include one or more information items, such as the duration of the packet, the periodicity, the start time locations or timestamps, number of the packets, in which the details are indicated in Table 4. An example of the signaling for an LL dedicated RU information field is shown in Table 5.

Table 4 shows information items that may need to be considered in the initial control frame or trigger frame.

TABLE 4

| Information items | Description |
|---|---|
| Duration of the | The field indicates the length of the PPDU |
| packet | that is transmitted by the supporting STA. |
| Number of reserved | This field indicates the number of the |
| packets | reserved packets. |
| Periodicity | This field indicates the periodicity of the |
| | packets transmitted by the supporting STA. |
| Reserved start | This field indicates each start time of the |
| timestamps | packets of the supporting STA. |

Table 5 shows the information field of a dedicated RU.

TABLE 5

| | | | |
|---|---|---|---|
| Duration of each | Duration of | periodicity | Reserved start |
| packet | the XIFS | | timestamps |

In an embodiment, a supporting STA that is supporting a LL STA for preemption may indicate with a CTS, its agreement when AP starts regular transmission and abruptly transmit LL traffic to a supported STA. The trigger frame may include the preemption request or negotiation for the supporting STA, and the CTS may consider a response of preemption confirmation information. The negotiation frame exchange is as discussed above. In an embodiment, the supporting STA may also be a LL STA with periodic LL traffic.

In an embodiment, any STA (RTA STAs) that has traffic qualified as RTA traffic may be eligible for uplink transmission on the LL RUs of a TXOP, such as they may all be supported STAs of the TXOP. In an embodiment, the AP may provide an indication of the RTA STAs that are eligible to be supported STAs during the LL RUs of a TXOP. This indication of supported STAs may be a long-term indication, such as in a beacon and that is applicable until the next beacon. This indication may alternatively be a per-TXOP indication that is carried in the beginning of the TXOP initiated by the AP. The supported STAs may be indicated by carrying User Info fields corresponding to each of the AIDs of the supported STAs in the MU-RTS trigger frame that initiates the uplink transmission. The RU Allocation field of the User Info field may carry the LL RU indication while there may be a separate field in the User Info field to indicate that the allocation is for uplink RTA traffic via preemption. There may be a special User Info field with the AID12 field set to a special reserved value for indicating RU allocation for low-latency traffic. In the body of that User Info field, there may be a limited number of additional AID12 fields that are used to identify the supported STAs. The indicated supported STA(s) may be allowed to preempt the ongoing transmission on the LL RUs at the pre-emption XIFS intervals for their RTA transmission(s).

In an embodiment, preamble detection may be needed so that the preamble of the LL/RTA STA may indicate that a LL STA is performing preemption. Preamble detection may allow other LL traffic STAs, as well as supporting STAs, to become aware of the LL STA performing preemption. The preamble may have a higher power to transmit, while after successful preemption, a normal power may be re-adjusted for the payload. Although some interference may occur to affect the regular transmission, the preamble with the higher power may have a chance to prioritize the LL traffic. The power of the preamble may be 1.2 times higher of the regular transmission. The factor of the power for the preamble may be designed in a frame item or by implementation. Some considered information items are shown in Table 6.

Table 6 shows information items that the PHY preamble may need to be considered.

TABLE 6

| | |
|---|---|
| Preamble power for | This field indicates the proportion of the power |
| preemption | that the preamble may need more compared |
| | with the regular transmission. |
| Preemption indication | This field indicates if the preemption has |
| | happened or not. A code 0 indicates no |
| | preemption happens. A code 1 indicates a |
| | preemption happens. |

One or more restrictions may be considered, in addition, one or more of the following constraints may need to be considered. In an embodiment, the LL RU may only be preempted once per TXOP. In an embodiment, the LL RU may be preempted multiple times but on the supporting STA's PPDU/PSDU. In an embodiment, the LL RU may be preempted multiple times from one supported STA. In an embodiment, the LL RU may be preempted multiple times from multiple supported STA. In an embodiment, the LL RU may be preempted multiple times on the supporting STA's PPDU/PSDU and the LL traffic's PPDU/PSDU. In an embodiment, there may be multiple supporting STAs serving on different LL RUs to support only one supported STA. In an embodiment, there may be multiple supporting STAs serving on different LL RUs to support multiple supported STAs.

In an embodiment, the LL RU may be distributed RU (dRU). In an embodiment, there may also be a restriction on the dRUs which are used for the LL RUs. For example, when the dRU used for LL RU may not allow preemption. In an embodiment, each dRU used for LL RU may occupy a minimum required number of tones (e.g., 1 tone per MHz). This tone limit may be, for example, to ensure successful and quick detection of the low-latency transmissions.

In an embodiment, an RTA STA may notify an AP for the need of preemption on the ongoing traffic within an information element, such as SCS, TWT, which may include the RTA traffic negotiation procedure.

In an embodiment, a request for the dedicated RU reservation and the need of a supporting STA's help may be included in the pre-negotiation procedure. The access category (AC), the traffic identifier (TID), traffic classification (TCLAS) information may be indicated in the elements to show the priority of the RTA traffic. If the AP agrees to support the RTA STA, it may response with an agreement setting up a duration such as TXOP or TWT information to register the procedure. An example of the information items that may be considered in the request and response frame is shown in Table 7 and Table 8, respectively.

Table 7 shows information items that the negotiation request frame may need for LL negotiation.

TABLE 7

| | |
|---|---|
| Dedicated RU request | This information item indicates if the STA subscribes to the dedicated |
| | RU for LL traffic without any help from supporting STAs. A bit 0 |
| | indicates no request. A bit 1 indicates the need of subscription. |
| Dedicated RU list | This information item indicates a list of the available RUs for LL |
| | purpose. |
| Dedicated LL RU | This information item indicates the potential AID or RU allocation of |
| | the LL RU. |
| Supporting LL | This information item indicates if the STA subscribes to the dedicated |
| request | RU for LL traffic with the help of supporting STAs. A bit 0 indicates |
| | no request for supporting STAs. A bit 1 indicates the need of |
| | supporting STA. |
| Roles | This indicates if the STA is willing to be a supporting STA or |
| | supported STA. |

Table 8 shows information items that the negotiation response frame may need for LL negotiation.

TABLE 8

| | |
|---|---|
| Status | This indicates if the STA agrees to serve the LL STA with the dedicated |
| | RU service. A status code such as “agree” means the AP agrees to serve. |
| | A status code such as “fail” means the AP cannot help for the LL traffic. |
| Dedicated RU list | This information item indicates a list of the available RUs for LL |
| | purpose that the AP may select. |
| Dedicated LL RU | This information item indicates the potential AID or RU allocation of |
| | the LL RU. |
| Supporting STA | It may include the AID of the supporting STA if there is a need |
| AID | requesting the supporting LL service. |

The supporting STA and supported STA may need to agree on the same dedicated LL RU as discussed above if the supporting LL request is 1 indicating that the supporting STA is needed. The AID of the supporting STA may also be shared to the supported STA during the response frame.

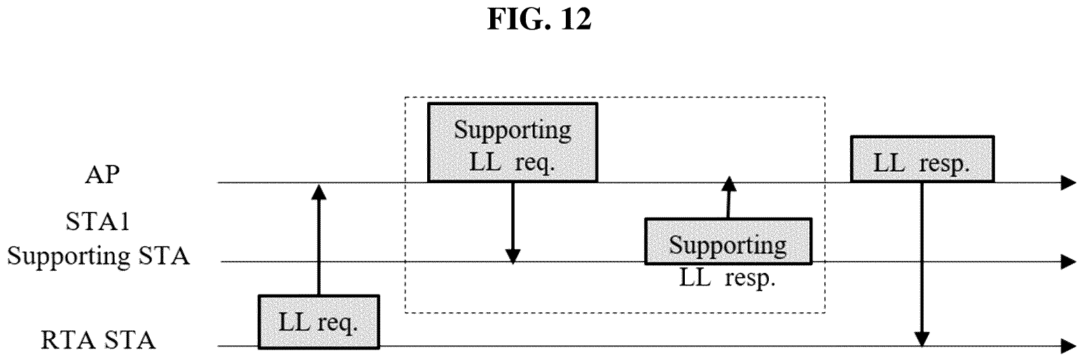

The AP may advertise and request a non-LL non-AP STA to be a supporting STA, particularly for uplink transmission, if the RTA STA sets the supporting LL request to 1 indicating support for reserving the dedicated RU. The request frame may include the preemption indication, channel usage rules as shown in Table 9, and also the AID of the supported STA, shown in Table 9. The AP may transmit a response with a Supporting LL response frame when a STA responds with an agreement. The AP may notify the RTA STA with only channel and BW information but may not assure the channel is reserved and available when there is no STA that agrees to be a supporting STA. The dash block in FIG. 12 shows that the AP is reaching a supporting LL STA to help reserve the channel. Once the supporting STA agrees to serve, the AP transmits the response frame to RTA STA.

FIG. 12 shows an example negotiation procedure where the RTA STA initiates in accordance with an embodiment. The negotiation procedure depicted in FIG. 12 is for explanatory and illustration purposes. FIG. 12 does not limit the scope of this disclosure to any particular implementation.

Referring to FIG. 12, the RTA STA transmits, to the AP, an LL request frame (LL req.) initiating negotiation. Subsequently, the AP transmits, to STA1, a Supporting LL request frame (Supporting LL req.) that request that STA1 be a supporting STA for the RTA STA LL request. In response, STA1 transmits, to the AP, a Supporting LL response frame (LL resp.) indicating that STA1 agrees to be a supporting STA for the RTA STA. Subsequently, the AP transmits, to the RTA STA, a LL response frame agreeing to perform the LL transmission.

Table 9 shows the information items that the supporting LL request frame may need for LL negotiation.

TABLE 9

| | |
|---|---|
| Roles | This indicates the roles that the STA is going to become. |
| Status | This indicates if the STA agrees to be the supporting STA. A status code |
| | such as “agree” means the STA agrees to serve. A status code such as |
| | “fail” means the STA cannot help for the LL traffic. |
| Supported | It may include the AID of the supported LL STA if there is a need |
| STA AID | requesting the supporting LL service. |

In an embodiment, an AP may also broadcast the service in any management frame, or control frame, such as a beacon frame or a discover frame. An RTA STA may transmit a response frame to the AP if the RTA STA discovers the service and is willing to become a supporting STA or RTA STA. Similar information items may be reconsidered in Tables 7-9. The LL confirmation frame may include the roles, AIDs of both supporting STA and RTA STA.

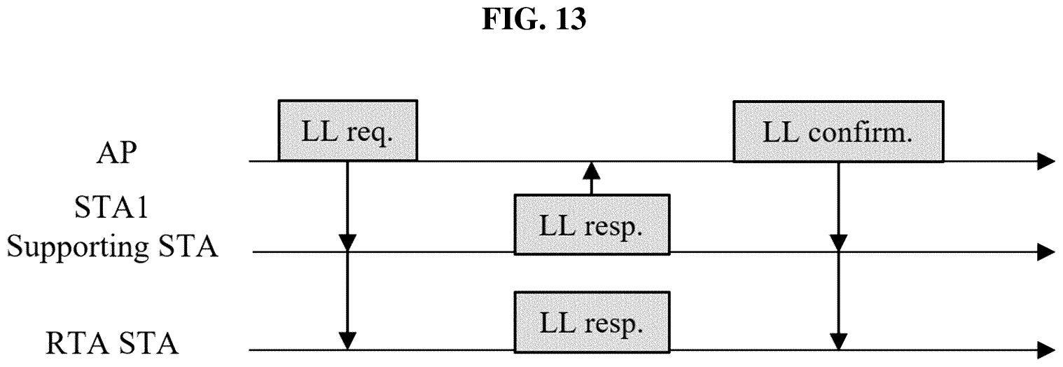

FIG. 13 shows an example negotiation procedure initiated by the AP in accordance with an embodiment. The negotiation procedure depicted in FIG. 13 is for explanatory and illustration purposes. FIG. 13 does not limit the scope of this disclosure to any particular implementation.

Referring to FIG. 13, the AP transmits, to STA1 and the RTA STA, a LL negotiation request frame (LL req.) which may include both supporting STA and supported STA request. In response, STA1 transmits, to the AP, an LL response frame (LL resp.) indicating agreement to be a supporting STA. The RTA STA transmits, to the AP, an LL response frame (LL resp.) indicating agreement to be a supported STA. Subsequently, the AP transmits, to STA1 and the RTA STA, a LL confirmation frame (LL confirm.). The AP may broadcast the LL negotiation request frame including both a supporting STA and Supported STA request. The AP may share the AID of STA1 and the RTA STA with each of the two STAs. The RTA services may have been requested.

In an embodiment, the supported STA (RTA STA) may also indicate the request for reserving a dedicated RU and find a supporting STA itself. An advertisement frame may include the above discussed information and transmits to the STAs nearby, such as the unsolicited TDLS discovery frame. After the STA agrees to support the RTA STA, the RTA STA may initiate the service request frame to AP with the supporting STA's AID.

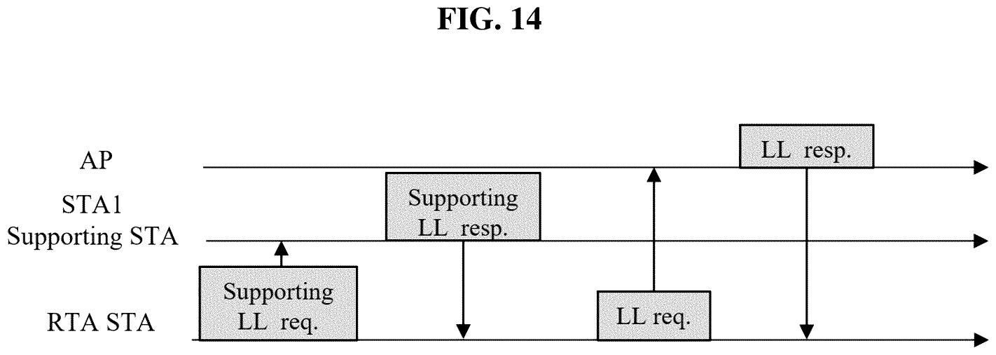

FIG. 14 shows an example negotiation procedure between an RTA STA and supporting STA in accordance with an embodiment. The negotiation procedure depicted in FIG. 14 is for explanatory and illustration purposes. FIG. 14 does not limit the scope of this disclosure to any particular implementation.

Referring to FIG. 14, the RTA STA transmits, to STA1, a Supporting LL request frame (Supporting LL req.) that requests STA1 to be its supporting STA. In response STA1, transmits, to the RTA STA, a Supporting LL response frame (Supporting LL resp.) that agrees to be the supporting STA. Subsequently, the RTA STA transmits, to the AP, an LL request frame (LL req.) requesting a dedicated RU for its LL traffic indicating STA1 as a supporting STA. In response, the AP transmits, a LL response frame (LL resp.) indicating agreement to provide the dedicated RU for its LL traffic.

In an embodiment, the supporting STA feature may be a capability of an STA, and an STA may indicate its capability to behave as a supporting STA by transmitting a UHR Capabilities element with a ‘Supporting STA capability’ field set to 1. Otherwise, the STA may set the Supporting STA capability field to 0. In an embodiment, the supporting STA behavior may be a mode that may be activated by an STA. The STA may transmit a new Action frame called Supporting STA Notification frame to indicate that it is changing its mode from non-supporting STA to supporting STA or vice versa. When an STA has indicated its capability of behaving as a supporting STA, the AP may consider it as a candidate for allocating the LL RUs in a preemptible TXOP.

In an embodiment, the supported STA feature may be a capability of an STA with LL or RTA traffic, and an STA may indicate its capability to behave as a supported STA by transmitting a UHR Capabilities element with a ‘Supported STA capability’ field set to 1. Otherwise, the STA may set the Supported STA capability field to 0. An STA may transmit a new Action frame called Supported STA Notification frame or LL Notification frame to indicate that it may have the LL traffic in the TXOP or TWT periodically or dynamically. An STA may also change its mode from non-LL STA to LL STA or vice versa. The AP may consider it and prioritize it as a LL candidate for allocating the LL RUs in a preemptible TXOP when an STA has indicated its capability of behaving as a supported STA.

In an embodiment, if there are N number of LL STAs, the AP may consider reserving N dedicated LL RUs for each LL STA.

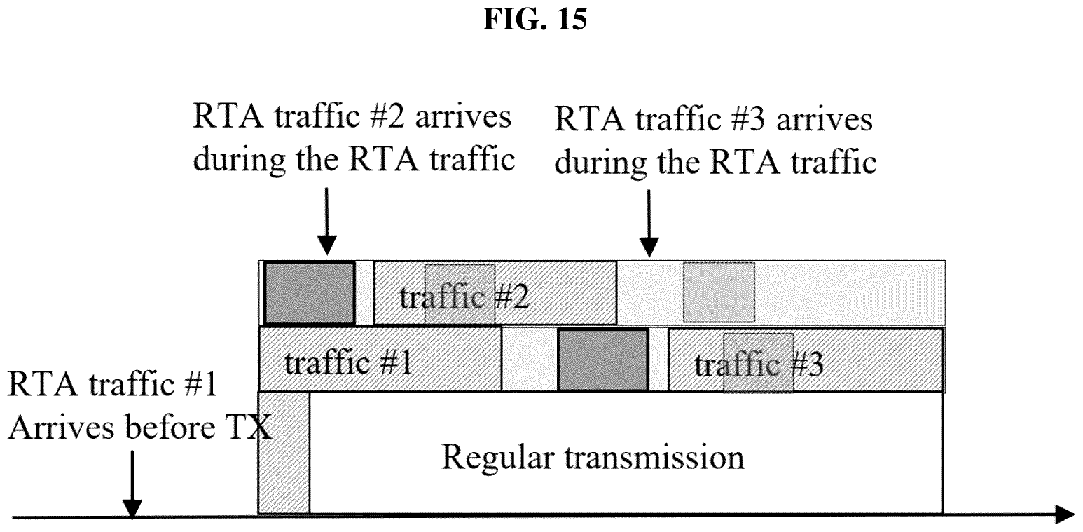

FIG. 15 shows an example multiple preemptions on two dedicated RUs in accordance with an embodiment. The multiple preemptions depicted in FIG. 15 are for explanatory and illustration purposes. FIG. 15 does not limit the scope of this disclosure to any particular implementation.

Referring to FIG. 15, three RTA traffics arrive in different times, traffic #1, traffic #2 and traffic #3. Traffic #1 arrives before the transmission begins, so the AP schedules the transmission for the first RU in the first time. Traffic #2 arrives during Traffic #1's use of the first RU. Traffic #2 checks the first RU to see if it's busy. After determining that the first RU is in use by Traffic #1, Traffic #2 checks the second RU to see if it's busy. Traffic #2 preempts the second RU after the first PPDU transmitted by the supporting STA. Traffic #3 arrives after Traffic #1 and Traffic #2 have both ended. Traffic #3 checks the first RU to determine if it's busy. Traffic #3 preempts the first RU after determining it is not busy. Determination of whether an RU is busy may be performed by CCA. Traffic may also preempt any of the valid RUs.

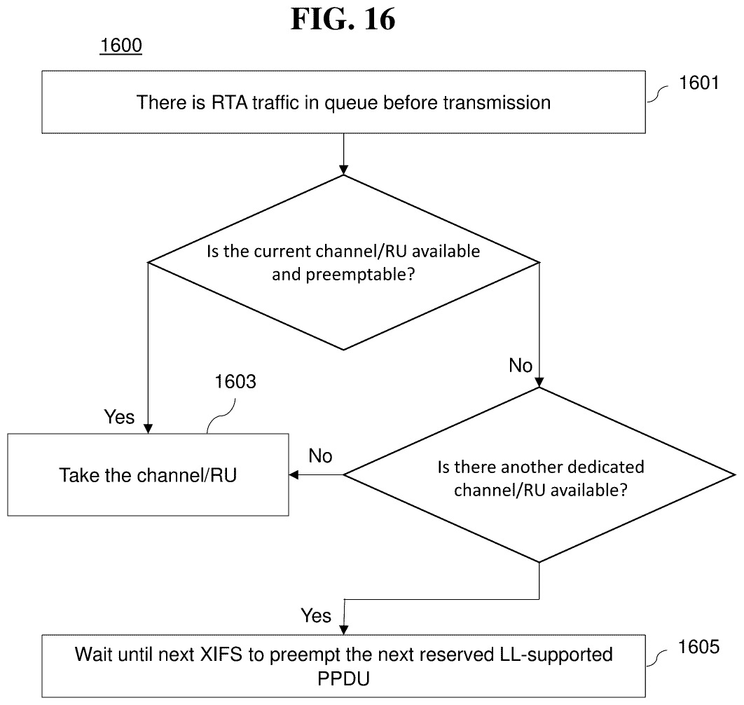

FIG. 16 shows an example traffic-side process depicting the procedure for determining a channel to preempt in accordance with an embodiment. The process depicted in FIG. 16 is for explanatory and illustration purposes. FIG. 16 does not limit the scope of this disclosure to any particular implementation.

Referring to FIG. 16, the process 1600 begins at operation 1601. In operation 1601, there is RTA traffic in queue before transmission. Operation 1601 may be followed by operation 1603 if there is a current channel/RU available and preemptable. Operation 1601 may be followed by operation 1605 if there is no current channel/RU available and preemptable and there is another dedicated channel/RU available. An AP may determine that the traffic should take the channel in the first time of the transmission. The AP may determine that the traffic should preempt PPDU's of the supporting STA during the transmission.

In operation 1603, the RTA traffic takes the channel/RU by preemption. The RTA traffic may determine not to take the channel/RU and instead take another dedicated RU.

In operation 1605, the RTA traffic waits until the next XIFS interval to preempt the next reserved LL supported PPDU.

Multiple AIDs for the LL STAs may be assigned. In addition, the RU allocations may indicate the dedicated RUs, and each LL RU information field may be modified accordingly.

In an embodiment, the AP may also only assign one RU for all the RTA STAs to preempt. The Supported STAs may perform channel contention during the XIFS intervals to transmit the uplink RTA traffic to the AP. In an embodiment, the XIFs interval may be divided into N slots of equal length. The value of N may be pre-determined and fixed or it may be indicated by the AP in the frame initiating the TXOP. In a variant, an initial portion of the XIFS interval may be left unassigned to any slot to ensure the supporting STA may switch to listen operation. For this mechanism to work, a carefully designed new preamble may be considered which when transmitted by one supported STA may be detected by another STA within less than a slot interval of XIFS/N. This may be provided to prevent collision among the contending supported STAs.

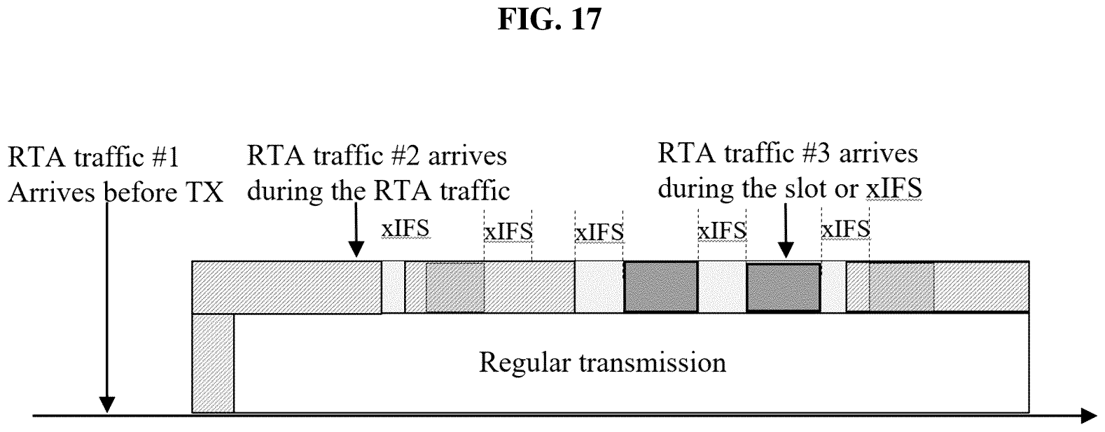

FIG. 17 shows multiple preemption on one RU in accordance with an embodiment. The preemption depicted in FIG. 17 is for explanatory and illustration purposes. FIG. 17 does not limit the scope of this disclosure to any particular implementation.

Referring to FIG. 17, the RTA traffic #1 arrives before the transmission. The AP schedules the RTA traffic #1 for the first time on the dedicated RU. Subsequently, the RTA traffic #2 arrives during the RTA traffic #1 use of the RU. The RTA traffic #2 preempts the PPDU of a supporting STA during the first XIFS interval after the RTA traffic #1 completes its transmission. The RTA traffic #3 arrives during the second PPDU of the supporting STA after the RTA traffic #2 completes its transmission. The RTA traffic #3 preempts the third PPDU of the supporting STA on the transmission during the fifth XIFS interval. The RTA traffic #3 completes its transmission as the regular transmission ends.

The RTA STA and the supporting STA may expect acknowledgement in the multi-STA BA and may need to wait for the SIFS interval after the whole PPDU transmission. If preemption of the RTA traffic happens, the BA in the dedicated RU may include both the supporting STA and supported STA's ACK.

The RTA traffic may expect a longer waiting time for a whole PPDU finishing transmission if the RTA traffic occurs in the middle of the regular transmission. The RTA traffic may consider adding paddings until the end of the transmission. The RTA traffic may decode the preamble of the next packet of the supporting STA which may comprise the successful preemption indication.

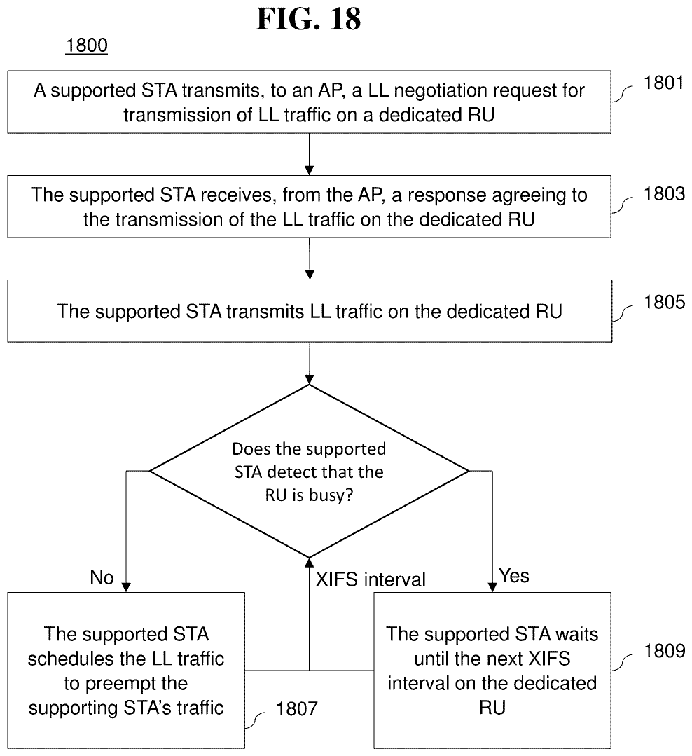

FIG. 18 shows an example supported STA-side process for preemption in accordance with an embodiment. The process depicted in FIG. 18 is for explanatory and illustration purposes. FIG. 18 does not limit the scope of this disclosure to any particular implementation.

Referring to FIG. 18, the process 1800 begins at operation 1801. In operation 1801, a supported STA transmits, to an AP, a LL negotiation request for transmission of supported STA's LL traffic on a dedicated RU. The supported STA may also request that the supporting STA be a supporting STA for the supported STA's LL traffic transmission prior to transmitting the LL negotiation request to the AP, identifying the supporting STA in the LL negotiation request.

In operation 1803, the supported STA receives, from the AP, a response agreeing to the transmission of supported STA's LL traffic on the dedicated RU. The AP may also identify a supporting STA in the response for the LL transmission.

In operation 1805, the supported STA transmits LL traffic on the dedicated RU. Operation 1805 is followed by operation 1807 when the supported STA doesn't detect that the dedicated RU is busy. Operation 1805 is followed by operation 1809 when the supported STA detects that the dedicated RU is busy.

In operation 1807, the supported STA schedules the LL traffic to preempt the supporting STA's traffic on the dedicated RU. The LL traffic may use padding if it ends too soon prior to the next XIFS interval.

In operation 1809, the supported STA waits until the next XIFS interval on the dedicated RU.

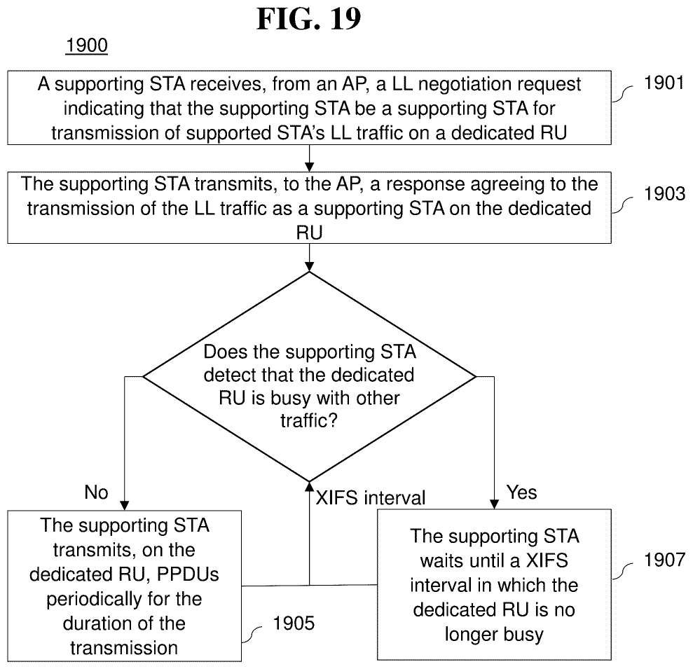

FIG. 19 shows an example supporting STA-side process for preemption negotiation in accordance with an embodiment. The process depicted in FIG. 19 is for explanatory and illustration purposes. FIG. 19 does not limit the scope of this disclosure to any particular implementation.

Referring to FIG. 19, the process 1900 begins at operation 1901. In operation 1901, a supporting STA receives, from an AP, a LL negotiation request indicating that the supporting STA be a supporting STA for the transmission of the supported STA's LL traffic on a dedicated RU. The supporting STA may instead receive an LL negotiation request from the supported STA.

In operation 1903, the supporting STA transmits, to the AP, a response agreeing to the transmission of supported STA's LL traffic on the dedicated RU. The supporting STA may instead transmit the response to the supported STA if the supporting STA received the request from the supported STA. Operation 1903 is followed by operation 1905 when the supporting STA doesn't detect that the dedicated RU is busy with other traffic. Operation 1903 is followed by operation 1907 when the supporting STA detects that the dedicated RU is busy with other traffic.

In operation 1905, the supporting STA transmits, on the dedicated RU, PPDUs periodically for the duration of the transmission. The supporting STA may transmit other data on the dedicated RU so long as the data adequately reserves the dedicated RU for the supported STA.

In operation 1907, the supporting STA waits until a XIFS interval in which the dedicated RU is no longer busy. The supported STA's traffic may be transmitted on the dedicated RU when the supporting STA detects that the dedicated RU is busy.

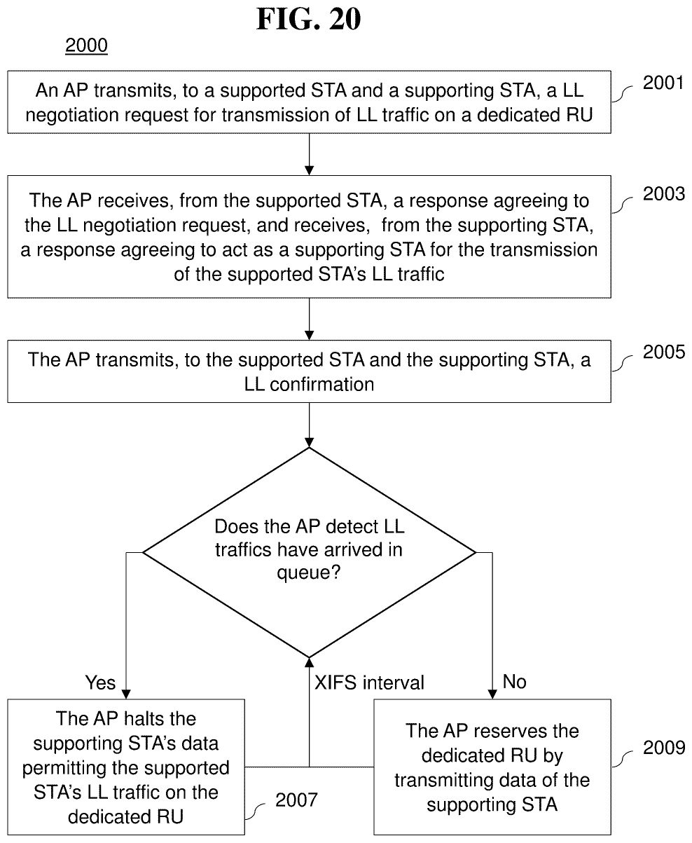

FIG. 20 shows an example AP-side process for preemption negotiation in accordance with an embodiment. The process depicted in FIG. 20 is for explanatory and illustration purposes. FIG. 20 does not limit the scope of this disclosure to any particular implementation.

Referring to FIG. 20, the process 2000 begins with operation 2001. In operation 2001, an AP transmits, to a supported STA and a supporting STA, a LL negotiation request for transmission of supported STA's LL traffic on a dedicated RU. The AP may instead receive an LL negotiation request from the supported STA.

In operation 2003, the AP receives, from the supported STA, a response agreeing to the LL negotiation request, and receives, from the supporting STA, a response agreeing to act as a supporting STA for the transmission of the supported STA's LL traffic. The AP may instead transmit a response agreeing to the transmission of supported STA's LL traffic where the AP received the negotiation request from the supported STA.

In operation 2005, the AP transmits, to the supported STA and the supporting STA, an LL confirmation. Operation 2005 is followed by operation 2007 when the AP detects LL traffic have arrived in queue for the dedicated RU. Operation 2005 is followed by operation 2007 when the AP doesn't detect that LL traffic has arrived in the queue for the dedicated RU.

In operation 2007, the AP halts the supporting STA's data permitting the supported STA's LL traffic on the dedicated RU.

In operation 2009, the AP reserves the dedicated RU by transmitting data of the supporting STA.

The disclosure provides mechanisms and procedures for preemption on a dedicated RU, such as a supported STA preempting a supporting STA's transmissions on the dedicated RU where the mechanisms and procedures improve low latency preemption by reserving the use of the dedicated RU for low latency traffic and preventing other undesirable STAs from using the RU.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An access point (AP) for facilitating communication in a wireless network, comprising:
a memory;
a processor coupled to the memory, the processor configured to cause:
transmitting, to one or more stations (STAs) that are associated with the AP, a first frame that allocates a first resource unit (RU) for low-latency traffic transmission and a second RU for non-low-latency traffic transmission, wherein the one or more STAs include a first STA with high priority access to the first RU and a second STA with low priority access to the first RU;
determining whether low-latency traffic for the first STA is queued for transmission;
transmitting the low-latency traffic for the first STA with priority to the first STA via the first RU based on a determination that the low-latency traffic for the first STA is queued for transmission; and
transmitting low-latency traffic or non-low-latency traffic to the second STA via the first RU based on a determination that the low-latency traffic for the first STA is not queued for transmission.

2. The AP of claim 1, wherein:
the processor is further configured to cause transmitting non-low-latency traffic to the second STA via the second RU; and
the low-latency traffic for the first STA is piggybacked to transmission of the non-low latency traffic to the second STA.

3. The AP of claim 1, the processor is further configured to cause:
determining that low-latency traffic for the first STA is queued for transmission after the transmitting the low-latency or non-low-latency traffic to the second STA via the first RU;
stopping transmission of the low-latency traffic or the non-low-latency traffic to the second STA via the first RU; and
transmitting the low-latency traffic for the first STA with priority to the first STA via the first RU.

4. The AP of claim 1, wherein the first frame includes information indicating whether a recipient STA is the first STA or the second STA.

5. The AP of claim 1, wherein the first frame allocates the first RU to the first STA and the second STA.

6. The AP of claim 1, wherein the processor is further configured to cause:
receiving, from the first STA, a second frame requesting high priority access to the first RU for low-latency traffic transmission; and
transmitting, to the first STA, a third frame indicating acceptance of the request in response to the second frame.

7. The AP of claim 1, wherein the processor is further configured to cause:
transmitting, to the second STA, a fourth frame suggesting low priority access to the first RU for low-latency traffic or non-low-latency traffic; and
receiving, from the second STA, a fifth frame indicating acceptance of the suggestion in response to the fourth frame.

8. The AP of claim 1, wherein:
the one or more STAs includes two or more first STAs;
each first STA has high priority access to the first RU; and
the transmitting the low-latency traffic to the first STA comprising transmitting low-latency traffic with priority to one or more first STAs via the first RU.

9. The AP of claim 8, wherein:
the first frame allocates two or more first RUs;
each first STA has high priority access to a respective first RU; and
the transmitting the low-latency traffic to the first STA comprising transmitting low-latency traffic with priority to one or more first STAs via the two or more first RUs.

10. A station (STA) for facilitating communication in a wireless network, comprising:
a memory;
a processor coupled to the memory, the processor configured to cause:
receiving, from an access point (AP) that is associated with the STA, a first frame that allocates a first resource unit (RU) for low-latency traffic transmission and a second RU for non-low-latency traffic transmission;
determining whether the first RU is busy or idle for a predetermined duration;
transmitting, to the AP, low-latency traffic or non-low-latency traffic based on a determination that the first RU is idle; and
abstaining from transmitting, to the AP, the low-latency or the non-low latency traffic based on a determination that the first RU is busy.

11. The STA of claim 10, wherein the first frame includes information indicating that the STA has low priority access to the first RU.

12. The STA of claim 10, wherein the determining whether the first RU is busy or idle comprising:
detecting a frame on the first RU; and
determining that a preamble of the frame is boosted in power by a predetermined value.

13. The STA of claim 10, wherein the processor is further configured to cause:
receiving, from the AP, a second frame suggesting low priority access to the first RU for low-latency or non-low-latency traffic; and
transmitting, to the AP, a third frame indicating acceptance of the suggestion in response to the fourth frame.

14. A station (STA) for facilitating communication in a wireless network, comprising:
a memory;
a processor coupled to the memory, the processor configured to cause:
receiving, from an access point (AP) that is associated with the STA, a first frame that allocates a first resource unit (RU) for low-latency traffic transmission;
determining whether the first RU is available or unavailable for preemption; and
transmitting low-latency traffic via the first RU without delay based on the determination that the first RU is available for preemption.

15. The STA of claim 14, the processor is further configured to cause:
abstaining from transmitting, to the AP, the low-latency traffic for a predetermined period based on a determination that the first RU is unavailable for preemption.

16. The STA of claim 14, wherein the first frame includes information indicating that the STA has high priority access to the first RU.

17. The STA of claim 14, wherein the processor is further configured to cause:
transmitting, to the AP, a second frame requesting high priority access to the first RU for low-latency traffic transmission; and
receiving, from the AP, a third frame indicating acceptance of the request of the second frame.

18. The STA of claim 14, wherein:
the first frame indicates a pre-scheduled length of an uplink frame; and
the processor is further configured to cause adding a length of padding so as to meet the pre-scheduled length of the uplink frame.

19. The STA of claim 14, wherein the transmitting low-latency traffic via the first RU comprising transmitting a frame including the low-latency traffic, wherein a preamble of the frame is boosted in power by a predetermined value.

20. The STA of claim 19, wherein:
the first frame allocates two or more first RUs; and
the determining whether the first RU is available or unavailable for preemption comprising determining whether one of the one or more first RUs is available or unavailable for preemption.
